(19) United States
(12) Patent Application Publication
(10) Pub. No.: US 2014/0316895 A1
(43) Pub. Date: Oct. 23, 2014

(54) MOBILE ADVERTISING SYSTEM

(71) Applicant: MEDIA MOBILE, LLC, Brooklyn, NY (US)

(72) Inventor: Shimon CHARACH, Brooklyn, NY (US)

(73) Assignee: MEDIA MOBILE, LLC, Brooklyn, NY (US)

(21) Appl. No.: 13/865,376

(22) Filed: Apr. 18, 2013

(51) Int. Cl. G06Q 30/02

(52) U.S. Cl. CPC G06Q 30/0267; G06Q 30/0261
USPC 705/14.58; 705/14.64

(57) ABSTRACT

In a cellular telephone system, an ad server is used to monitor activities of a cell phone. When a call is made from the cell phone to third party, an ad is presented on the cell phone to its user while the voice channel is established. The ad is selected based on a profile of the user or his geographical location.

### RELATED APPLICATIONS

None

### BACKGROUND OF THE INVENTION

A. Field of Invention

This application pertains to a system and method of providing advertising on hand-held and similar devices, including cell phones and the like while a telephone voice channel is being established. Alternatively, ads are delivered to hand-held device based on their geographical location and/or proximity to a particular venue.

B. Description of the Prior Art

Various hand-held devices have become ubiquitous in various activities, ranging from business to entertainment, shopping, travel, etc. to the point where many people could not conceive living without them. Such devices are used by individuals as primarily means of communicating with each other as well as with various service providers and other entities.

A typical telephone call on a cell phone requires fairly complicated switching protocols that may take significant amount of time. The present invention provides a means of delivering ads to a caller during the time that the call is being completed.

### SUMMARY OF THE INVENTION

A system constructed in accordance with this invention includes an ad server that monitors the activities of cell phones. Inherently, after a request for a voice channel is made to another party, a cell phone enters into a standby mode in which it is waiting for a voice channel to be established. In the present invention, during this waiting time. An ad is presented to the user through the cell phone. The ad could be audio-only or audio-visual and may be generic or may be selected on a profile of the user, based on his current geographic location or other criteria. When the call is completed, the ad is terminated and the user may proceed with the call. If the called party is busy, or a channel is not established within a predetermined time period, the user gets an appropriate message and the call is terminated.

In an alternate embodiment, the current position of a user is monitored and if the user is at or near a certain location, a message is sent to him from a particular advertiser, typically a store at said location. In this embodiment, the message can be an immediate special offer selected to encourage the user to visit the store, or other promotional material or information.

### BRIEF DESCRIPTION OF THE DRAWINGS

FIG. 1 shows a block diagram of a system constructed in accordance with the present invention;

FIG. 2 shows a somewhat simplified connection diagram for a system user;

FIG. 3 shows a flow chart illustrating how the customer accesses services using the system of FIG. 1;

FIG. 4 shows an alternate embodiment of the invention wherein a cell phone user receives messages from nearby venues; and

FIG. 5 shows a flow chart for the embodiment of FIG. 4.

### DETAILED DESCRIPTION OF THE INVENTION

In the following description, the term hand-held device' refers to various devices that can provide electronic communications and content to the respective user via either a cell phone system, Internet, or both. Such devices include such devices as smart phones, tablets, laptops, etc. For the purpose of illustrating the invention, the system is now described in conjunction with a smart phone, however, it should be understood that the description is equally applicable for any of the other hand-held devices as well.

The term “completed call” refers to a voice channel being established between two parties so that they can start communicating. The term “ ad” refers to advertisements from various providers, but could include information and other content that may be of interest to a cell phone user. The term “standby” refers to the state during which a cell phone is waiting for the completion of a call after a request for call with another party has been sent.

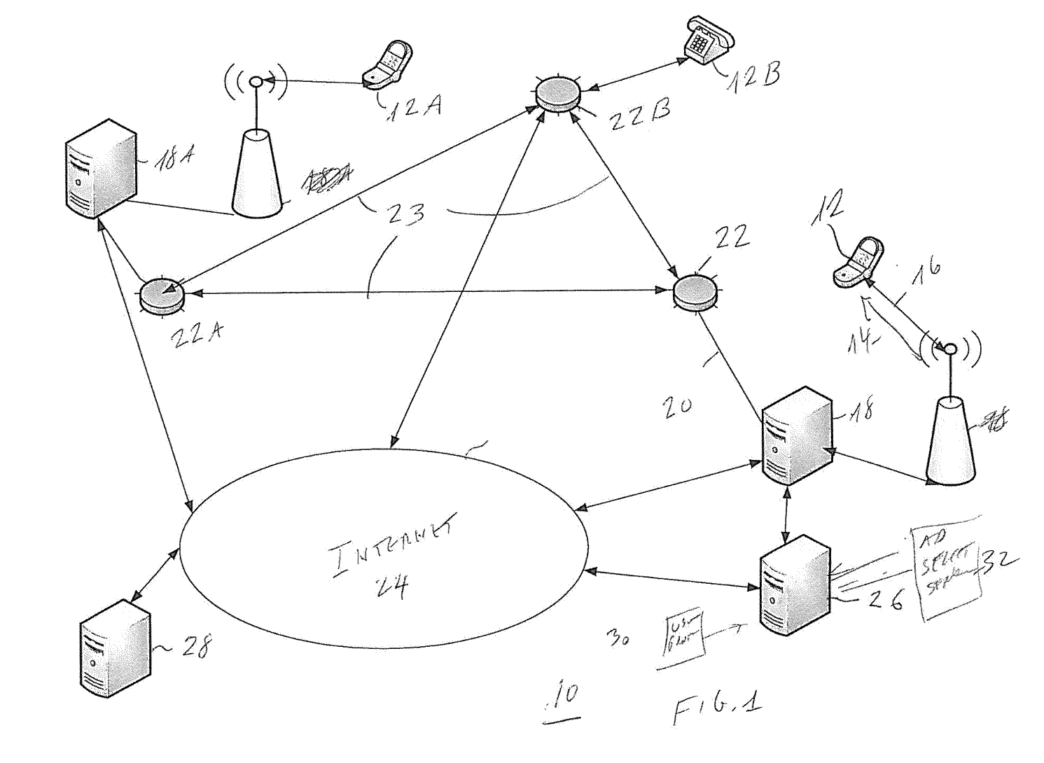

Referring first to FIG. 1, in system 10 a customer is using a portable device, such as a smart phone 12 for voice communications and data communications to obtain content. Device 12 is connected by a voice channel 14 and a data channel 16 with a base station 18. The voice channel 14 provides standard telephone communications for the smart phone 12 while data channel provides an Internet connection (as well as other information) as described in more details below.

The base station 18 is connected by a communication line 20 to a POTS or other standard landline portal 22. All standard landline voice communications for the smart phone 12 are provided through line 20 and the portal 22.

Portal 22 is part of a landline POTS network including several other portals 22A, 22B interconnected by trunk lines 23. Each of these portals are operatively connected to other phones and provide standard communication between them. For example, portal 22A is connected to a base station 18A to a cell phone 12A, portal 22B is connected by conventional means to a land line phone 128, etc.

Of course other means of establishing communication between any two phones may be used as well. For example, a voice channel may be established between any of the phones using VOIP through Internet 24.

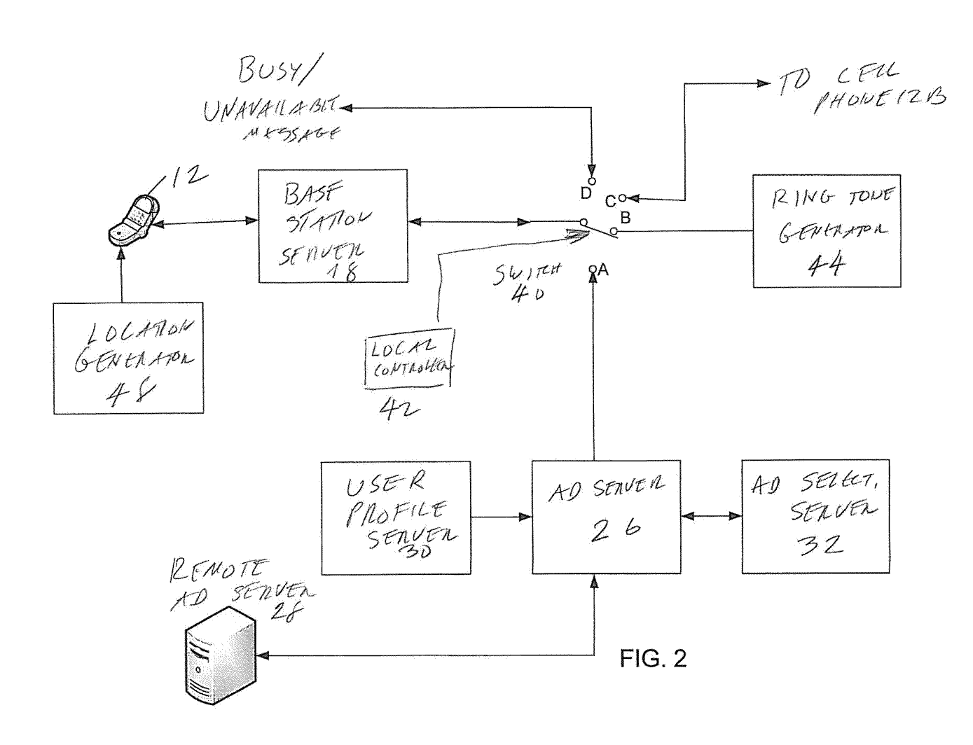

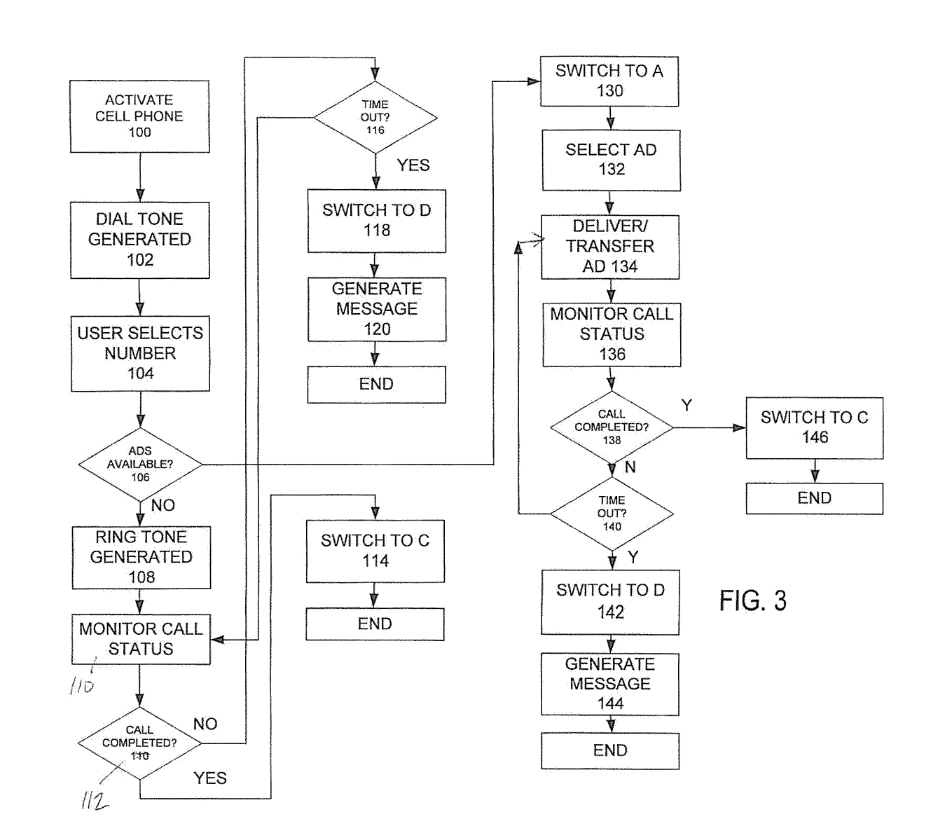

In addition, in accordance with this invention, cell phone 12 also receives selectively advertisements from local server 26. The advertisements are obtained from one or more advertisement servers 28. One embodiment for this operation is now described in conjunction with FIGS. 2 and 3. FIG. 2 shows a very simplified block diagram showing some of the signal paths for the phone 12 during a typical call and some of the components involved in establishing calls and delivering ads to the cell phone 12. These components include a switch 40, a ring generator and a local controller 42. It should be understood that these components are shown in the figure symbolically as discrete components purely for illustration purposes, and they are implemented preferably digitally either in base station server 18 or in another equivalent server.

Referring now to FIG. 3, in step 100, a user activates cell phone 12 to initiate a calling process to call phone 12B. The process is a standard process for establishing voice communication between phones 12 and 12B modified for selectively presenting ads to the user as follows. When the cell phone 12 is activated to make a call a standard protocol is initiated to establish the voice channel as part of this protocol, the cell phone 12 is connected through the base station server 18 to a switch is an electronic switch arranged to selectively connect the cell phone 12 to one of four components. During this initial period, a conventional dial tone is generated (step 102) and presented to the user. The user uses a keyboard to dial the number of cell phone 12B (step 104). Alternatively, the user selects the number of cell phone 12B from a contact list or using other well known means such as voice activation, etc.

Once the cell phone number of the called phone 12B is presented to cell phone 12, the phone 12 enters into a standby mode while waiting for the voice channel to be established. This process is symbolically illustrated as a switch having four positions having four positions A, B, C and D. The position of the switch 40 is controlled by a local controller which generates command signals to move the switch to one of the four positions in response to signals from server 18.

In accordance with this invention, as the cell phone 12 goes into standby mode, ad server 26 determines whether an ad is available for presentation to the phone 12 (step 106). If no ad is available for some reason, the process follows the standard standby protocol. That is, the switch 40 is moved to position B and a ring signal from ring generator 44 is presented to the phone 12 (step 108). In the next step 110, the status of the calling process is monitored. In step 112 a check is performed to determine if the call has been completed. If it has, then in step 114, the switch is moved to position C, the voice channel is established and the process is terminated.

Back to step 112, if the voice channel has not been established, then in step 116 a check is performed to determine if a time out condition has occurred. If a certain predetermined time has not expired, then the process loops back to step 108. If no call is completed before the designated time-out period, then in step 118 the switch is moved to position D. A message indicating a busy or unavailable condition is then generated and delivered to the phone 12 (step 120) and the process ends.

If an ad is available in step 106, then in step 130, the switch 40 is moved to position A. In step 132 the ad server 26 selects an ad appropriate for cell phone 12 (and, of course, its user). In step 134 the selected ad is delivered to the cell phone 12. In one embodiment, the ad is streamed either as an analog or a digital signal to the phone 12. In another embodiment, the whole ad is transferred to the phone 12 where it is stored, and then played.

As the ad is being played to the user, the call process is monitored in step 136. If the user of cell phone 12B answers the call as detected in step 238, then in step 146 the switch 40 is moved to position C and a voice channel is established between phones 12 and 12B. The process is then ended.

If no answer is detected in step 138 then in step 140 a check is performed to determine if a time out condition has occurred. If the time out has not occurred, the process loops back to step 134 and the ad is continued to be played for the user of phone 12. If a time out condition is detected in step 140 then in step 142 the switch is moved to position D, a busy/unavailable message is sent to the phone 12 in step 144 and the process ends.

The ads can be audio messages or audio visual messages. Moreover, while, the term ‘ads’ implies commercial activity of one kind or another, the term should be understood to mean other kinds of content, such as current information about an event, a locality, etc.

The selection and delivery of ads is performed using three servers: the ad server 26, the user profile server 30 and the ad selection server 32. The actual ads are received from other sources, such as ad source 28 and are either obtained from server 28 and delivered “live” to phone 12, or are obtained ahead of time, stored locally and then delivered. In one embodiment, as described above, a selected ad can be delivered and stored on phone 12 as well.

In one embodiment of the invention, the user profile server is used to store various information about the users of the system based on their profile, information that can be used to select what ads would be appropriate for each particular user. The ad selection server 32 receives information about the various ads that are available for presentation to its users. The ad selection server analyses this information and then correlates the information about the ads with the profile of various users. For example, the profile of a particular user may indicate that the user likes country music. The ad selection server 32 selects ads that have a correlation with country music lovers. The ad server 26 determines if and when ads are to be delivered to each user and obtains the respective ads selected by the ad selector server 32.

One criteria that can be used in the ad selection process is the physical or geographic location of a user. In one embodiment, this location can be the user's domicile, or workplace as indicated in his profile. In another embodiment, a user's location is actively determined and provided to the ad selection server. For example, cell phone 12 can include a location generator 48 that determines the current location of the phone 12. This information can then be made available to the ad selection server 32.

In one embodiment of the invention, instead or in addition to the user making a call, other events are used as triggers for delivering ads to the user, using other mechanisms, such as SMS messages and push technology.

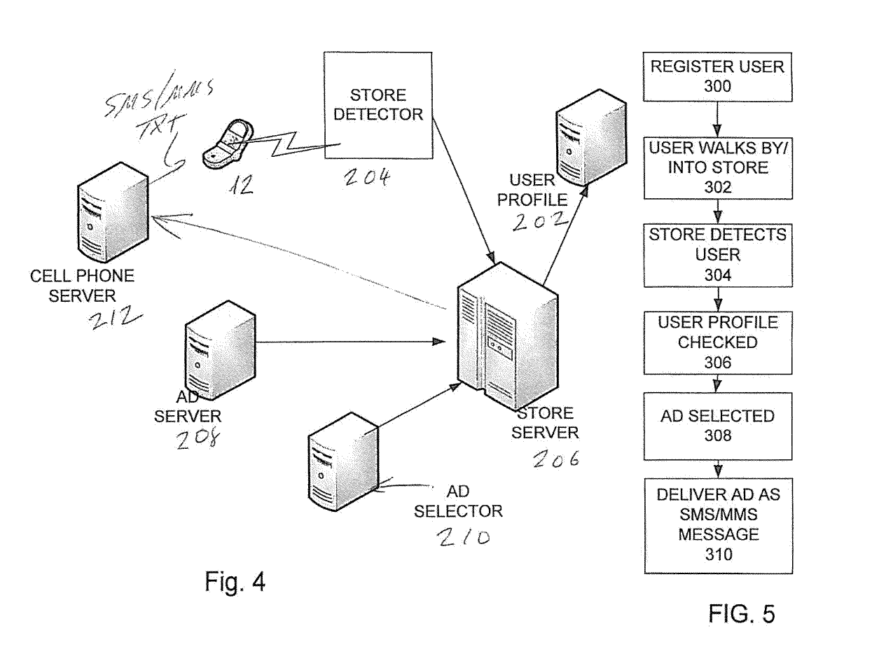

Details of this latter embodiment are shown in FIG. 4 and the actual operation of the system 200 is illustrated by the flow chart of FIG. 5. The other elements of the system 200 include a store detector 204 managing one or more stores or other venues at predetermined geographical locations, a store server 206 monitoring activities at various stores or other venues, an ad server 208 used to store ads and/or other content that can be delivered to users as described below, and an ad selector 210. Ads are delivered to the user by a cell phone server 212.

The system 200 may operate as follows. Starting in FIG. 5, in step 300 a user is registered and his phone number (of cell phone 12) and other information are collected. This information is then used to generate user profiles which are then stored in user profile 202.

After the profiles have been collected and the profile server has received and stored these profiles, the store server 206 starts monitoring activities at various stores. At a particular instance, the user walks in or walks by a particular store, and is detected by store detector 204 (step 304). This detection may be implemented using various means. One technique is to monitor the actual position of cell phones in the system using their GPS and compare this actual or current position with the location of a store. If they are near or overlap each other, it can be assumed that the cell phone is near or in a particular store. An alternate means is by determining that the cell phone 12 has been connected to wireless network (WiFi) in the store. Another way to detect cell phone 12 near a store is based on Bluetooth or near field technologies.

Once the cell phone 12 is detected, the profile of the corresponding user is checked (step 306) in user profile server 202. The ad selector 210 selects an ad appropriate for the cell phone 12 user and the selected ad is provided to the store server 206. The store server 206 then transmits the ad to the cell phone server 212 which then sends the ad to the cell phone 12. The ad is in the form of an SMS or MMS message. Alternatively, the ad is delivered to the cell phone in the form of an alert message or other similar means.

Obvious, numerous modifications may be made without departing from the scope of the invention as set forth above.

I claim:

1. A system for providing wireless communication and advertisement to a device associated with a customer comprising:
a base station in wireless communication with the device; and
an ad manager connected to said base station and receiving selectively ads, said ad manager server being adapted to monitor activities of said device and to transmit an ad to the device while the device is in standby mode waiting for a voice communication channel with another party.

2. The system of claim 1 wherein said ad manager includes a switching element selectively providing one of a connection to the other party, a prerecorded message, and an ad to the device during said standby mode.

3. The system of claim 1 wherein said ad server is adapted to select said ad based on a profile of a user associated with the device.

4. The system of claim 1 wherein said ad server is adapted to select said ad based on a geographic location of the device.
